(19) United States
(12) Patent Application Publication
(10) Pub. No.: US 2026/0094798 A1
(43) Pub. Date: Apr. 2, 2026

(54) ION OPTIC THAT CAN BE INSERTED INTO AND REMOVED FROM A MASS SPECTROMETER IN A NON-DESTRUCTIVE MANNER

(71) Applicant: Bruker Daltonics GmbH & Co. KG, Bremen (DE)

(72) Inventors: Sebastian BÖHM, Bremen (DE); Henning PEISE, Bremen (DE); Ewgenij KERN, Bremen (DE); Andreas HAASE, Bremen (DE)

(21) Appl. No.: 19/347,912

(22) Filed: Oct. 2, 2025

(30) Foreign Application Priority Data
Oct. 2, 2024 (DE) 102024128668.7

(51) Int. Cl. H01J 49/06

(52) U.S. Cl. CPC H01J 49/06

(57) ABSTRACT

An ion optic that can be inserted into and removed from a mass spectrometer in a non-destructive manner is described. Also described is a set comprising an ion optic according to the invention and a receiving element for the ion optic. Furthermore described is a mass spectrometer, in particular a MALDI-TOF mass spectrometer, comprising an ion optic according to the invention and/or a set according to the invention.

### BACKGROUND OF THE INVENTION

### Field of the Invention

The present invention relates to an ion optic that can be inserted into and removed from a mass spectrometer in a non-destructive manner. The present invention also relates to a set comprising an ion optic according to the invention and a receiving element for the ion optic. The present invention also relates to a mass spectrometer, in particular a MALDI-TOF mass spectrometer, comprising an ion optic according to the invention and/or a set according to the invention.

### Description of the Related Art

The invention is defined in the appended patent claims. Furthermore, preferred aspects of the present invention are apparent from the following description, including the examples. Insofar as certain embodiments are designated as preferred for an aspect according to the invention, the corresponding explanations also apply in each case to the other aspects of the present invention, mutatis mutandis. Preferred individual features of aspects according to the invention (as defined in the claims and/or disclosed in the description) can be combined with each other and are preferably combined with each other, unless otherwise apparent to the skilled person from the present text in individual cases.

The performance of a mass spectrometer can be reduced by contamination of its components, such as ion sources. During operation of a MALDI desorption ion source, for example, a sometimes visible coating of organic material forms on the electrodes. In the state of the art, such coatings in mass spectrometers are described by Girard et al. (Journal of Chromatography Science, 2010 October, 48(9), 778-779) and Kenneth L. Busch (“Ion Burn and the Dirt of Mass Spectrometry,” online publication, Sep. 1, 2010) on ion optics. The insulating organic coating charges during operation of the ion source, thereby generating an electrical interference field that superimposes itself on the electrical target field generated between the electrodes and the MALDI sample carrier during operation of the desorption ion source, and thus leading to interference with the acceleration process. In particular, field changes interfere with the focusing properties of the acceleration electrodes. As a result, the ion beam is no longer well focused on the detector. In addition, flight time errors increase in TOF-MS. The increased flight time errors lead to a drop in resolution and poorer mass accuracy, as the subtraction conditions are no longer constant due to the charges.

One noticeable effect of such a coating is, for example, a decrease in the ion throughput to the mass analyzer connected to the ion source. The reduced ion throughput in turn requires the additional recording and addition of spectra in order to maintain a certain level of quality in the mass spectra. The reduction in ion throughput also limits the number of analyses that can be performed per sample and reduces the detection limit of the mass spectrometer.

Girard et al. describe a method in which the charging effect can be neutralized by simply reversing the polarity of the ion source, which changes the polarity of the ions to be analyzed. Since ions of both polarities are produced in a MALDI process, the polarity of the acceleration field would have to be reversed for the analogous application of the method according to Girard et al. However, this method only addresses the symptoms of throughput loss in the ion source and promises only short-term effectiveness.

Regardless of the short-term solution mentioned above, there is therefore a regular need to remove the coating and, thus, restore the performance of the mass spectrometer. Under certain circumstances—if cleaning is not able to restore the approximate ideal condition of an ion optic—it must be replaced with a new, clean one.

The state of the art contains cleaning methods that can at least partially remove contamination. Patent application US 2004/0163673 A1 (Holle et al.) describes, for example, a sample carrier dummy with bristles that can remove interfering deposits by “scrubbing”, as well as a spray cleaning device that uses the negative pressure in the vacuum chamber of the ion source to direct a jet of solvent onto the acceleration electrodes and to loosen and remove deposits by its impact. Patent application DE 10 2008 008 634 A1 (Holle et al.) also discloses a method in which the coating is removed by local application of heat.

Another method for removing the coating, which is still used in practice, is manual cleaning after venting and opening the mass spectrometer. Cleaning is then usually carried out with solvents such as ethanol or acetone, but in the case of tough contaminants, it may also involve sanding with abrasive cleaning agents (such as toothpaste). Since cleaning is difficult when the ion optic is installed due to the confined space, and because one wants to avoid contaminating adjacent components with the dissolved dirt during cleaning, it is usually removed for this purpose.

The removal and cleaning themselves are usually fairly straightforward steps that may require some experience, but no special knowledge. These steps can therefore be carried out by trained personnel without any major problems. However, it becomes difficult when the removed parts have to be put back in their place in the mass spectrometer. The necessary use of electromagnetic forces and fields to control and manipulate ions means that there are positioning specifications for the ion optics used that only allow narrow tolerance intervals. These tolerances should preferably not exceed ten micrometers, and in any case should be less than 20 micrometers. For example, the surface-normal distance between a MALDI sample carrier with a sample applied to it and the first acceleration electrode significantly determines the acceleration distance of ions on their way to the mass analyzer and thus the kinetic energy accumulated over the distance. The control and correct adjustment of this kinetic energy is crucial for the operation of, for example, a time-of-flight mass spectrometer. Even more crucial is the change in direction of the ions due to an offset perpendicular to the ion axis or a tilt of the lens package. Deviations in the surface-normal distance between the sample and the acceleration electrode (also indirectly via a lateral offset/shift) can therefore significantly impair mass spectrometric analysis.

In addition, ion optics must be supplied with power. This means that the corresponding electrical supply lines, which are usually screwed together, must be disconnected when the ion optic is removed and reconnected when it is reinstalled, which requires additional steps and increases the risk of incorrect or inaccurate installation or insertion of the ion optic after removal.

For these reasons, specially trained personnel from the manufacturer or its authorized dealers are often required to reinstall an ion optic that, for example, has been removed for cleaning. This may involve readjusting the reinstalled ion optic in the mass spectrometer to ensure that it is reinstalled with high positional accuracy. If there are no adjustment marks or similar features in the mass spectrometer, it is often not only the ion optic that needs to be realigned with respect to the mass spectrometer. It may then be necessary to also realign other components of the mass spectrometer, such as a reflector or a detector (in two planes), not to mention additional fine tuning of the supply voltages. The personnel costs for such maintenance work are considerable and also involve high costs for the user of the mass spectrometer, who, for example, has to pay the travel expenses of the qualified personnel.

US 2009/0242747 A1 (Guckenberger et al.) discloses a mass spectrometer in which an ion source and various ion optic elements are combined into a subassembly. The subassembly is removed from the mass spectrometer for the purpose of cleaning from contaminations arising during operation and reinserted while maintaining vacuum.

U.S. Pat. No. 7,601,951 B1 (Whitehouse et al.) describes an atmospheric pressure ion source designed so that all or part of the vacuum components, such as ion-focusing and ion-transporting electrostatic lenses and ion guide systems, and two or more vacuum stages combined in a single unit are removed from an ion source or vacuum housing.

U.S. Pat. No. 7,667,193 B2 (Finlay) discloses a mass spectrometer with a modular design to provide a user with a personalized analysis device by installing a personalized analysis module.

EP 2 555 224 A1 (Kern et al.) discloses an arrangement of a carrier holder and a complementary carrier for a removable ion optic of a mass spectrometer.

### SUMMARY OF THE INVENTION

Initially, particular reference was made to MALDI ion sources. However, the invention to be presented below is not limited to specific types of ion generation or guidance in a mass spectrometer. Similar considerations can also be made for electrospray ionization sources, electron impact ion sources, ion sources with chemical ionization, and others.

In view of the state of the art described above, the primary problem to be solved by the present invention was to provide an ion optic that can be easily removed from a mass spectrometer and then quickly reinserted into the mass spectrometer, for example after cleaning. The ion optic to be provided should also be able to be removed from the mass spectrometer and reinserted into it correctly without any special prior knowledge and without requiring any special technical skills for connecting and contacting the ion optic. Preferably, it should also be possible to remove and insert the ion optic without tools and/or adjustment, i.e., without the need for adjustment of the ion optic after insertion into the mass spectrometer, which is often time-consuming and requires expert knowledge.

Further problems to be solved result from the following description and the claims.

The primary problem underlying the present invention is solved by an ion optic that can be inserted into and removed from a mass spectrometer in a non-destructive manner, comprising
an element for reversible attachment of the ion optic inside the mass spectrometer, and
an element for ensuring reproducible positioning of the ion optic in the mass spectrometer,
wherein
i) the element for reversible attachment of the ion optic
and/or
ii) the element for ensuring reproducible positioning of the ion optic simultaneously serves as a contact point for applying an electrical voltage (or an electrical potential or an electrical current) to the ion optic (i.e., at least to parts of the ion optic, such as in particular to one or more electrically conductive components for targeted manipulation of ions).

Both a DC voltage and an AC voltage, for example an RF voltage, can be applied to the ion optic via the element for reversible attachment of the ion optic and/or the element for ensuring reproducible positioning of the ion optic. Preferably, the element for reversible attachment of the ion optic and/or the element for ensuring reproducible positioning of the ion optic serves as a contact point for applying a DC voltage to the ion optic, preferably for applying a DC voltage in the range of 4 to 20 kV.

According to the present invention, ion optic can basically be understood to mean any structural element of a mass spectrometer and/or ion source that serves for targeted (i.e., intended, purposeful) manipulation of ions, preferably for targeted manipulation of the beam path of an ion beam. Examples of ion optics or examples of (electrically conductive) components of ion optics for targeted manipulation of ions, preferably for targeted manipulation of an ion beam, in the context of the invention include acceleration, shielding, and/or mass electrodes of an ion source, but also injection capillaries, multipole rod systems, ion funnels made of ring electrodes, ion deflectors (capacitors) and the like.

An ion optic according to the invention can be designed as a single piece or as multiple pieces and can comprise, for example, several (electrically conductive) components for targeted manipulation of ions. An ion optic according to the invention can also comprise a holder in which the components for targeted manipulation of ions can be arranged and by which they can be held. An ion optic according to the invention may also comprise components made of an insulating material, by means of which, for example, in the case of the presence of several electrically conductive components for targeted manipulation of ions in an ion optic, electrical contact between these several electrically conductive components can be avoided.

The element for reversible attachment of the ion optic inside the mass spectrometer serves, on the one hand, to ensure secure attachment and a firm hold of the ion optic in the mass spectrometer and, at the same time, enables easy and in a non-destructive manner removal of the ion optic and reattachment of the ion optic in the mass spectrometer. The reversible attachment can be achieved, for example, by means of a spring, a magnetic element, a pneumatic element, a hydraulic element, or a combination of one or more of the aforementioned elements.

The element for ensuring reproducible positioning of the ion optic in the mass spectrometer serves to enable the ion optic to be positioned in the same way and/or at the same position in the mass spectrometer each time after removal from the mass spectrometer, so that there is no need for time-consuming adjustment of the ion optic after removal and reinsertion into the mass spectrometer.

An essential aspect of the invention is the realization that i) the element for reversible attachment of the ion optic and/or ii) the element for ensuring reproducible positioning of the ion optic can, in addition to its primary function, also be used as a contact point for applying an electrical voltage to the ion optic. This enables a simpler and more compact design of the ion optic, as it allows other connection points on the ion optic for electrical contact to be partially or completely dispensed with. This also eliminates or reduces the risk of damage to such additional electrical connection points, which are often delicate due to the size of the ion optic. The possibility of reducing electrical connection points and/or making them more compact is particularly advantageous because high voltages are usually applied to ion optics and electrical connection points for high voltages are subject to particularly high technical requirements, i.e., simplifying the electrical connections can also significantly simplify and improve the structural requirements for the ion optic as a whole.

Another advantage associated with the simultaneous use of i) the element for reversible attachment of the ion optic and/or ii) the element for ensuring reproducible positioning as a contact point for applying an electrical voltage to the ion optic is that it further simplifies the process of removing and inserting the ion optic, as the operator now has less or no need to worry about the electrical contact of the ion optic. This further reduces potential sources of error when removing and, in particular, reinserting the ion optic.

An ion optic according to the invention is preferred, wherein the element for reversible attachment of the ion optic simultaneously serves as a contact point for applying an electrical voltage to the ion optic. Further preferred is an ion optic according to the invention, wherein only the element for reversible attachment of the ion optic serves as a contact point for applying an electrical voltage to the ion optic.

The invention comprises embodiments in which the function of the reversible attachment of the ion optic and the function for ensuring reproducible positioning of the ion optic are realized by one and the same element. However, it is preferred that both functions are realized by different elements.

An ion optic according to the invention may also comprise more than one element for reversible attachment of the ion optic and/or more than one element for ensuring reproducible positioning of the ion optic, wherein the multiple elements can be of the same or different construction and design.

For example, an ion optic according to the invention may have two different types of elements for ensuring reproducible positioning of the ion optic, wherein one of these elements serves primarily to correctly align the ion optic inside the mass spectrometer (for example, so that a second element intended for finer positioning is first correctly aligned with a possible complementary counterpart inside a mass spectrometer and correctly attached to this counterpart) and the second of these elements can serve to achieve finer, consistently reproducible positioning of the ion optic inside the mass spectrometer with, for example, an accuracy in the micrometer range. One of several elements of different types that may be present for ensuring reproducible positioning can, for example, also be designed as a rotation prevention which, after the ion optic has been positioned inside a mass spectrometer, additionally ensures that the ion optic is held firmly in place and remains in this position.

An ion optic according to the invention is preferred, wherein the ion optic comprises at least three, preferably six, elements for reversible attachment of the ion optic

and/or
comprises at least three elements for ensuring reproducible positioning of the ion optic.

The presence of multiple elements for reversible attachment of the ion optic contributes to a more secure hold of the ion optic. The presence of multiple elements for ensuring reproducible positioning of the ion optic increases the reproducibility and accuracy of the attachment of the ion optic.

Further preferred is an ion optic according to the invention, wherein
i) the elements for reversible attachment of the ion optic
and/or
ii) the elements for ensuring reproducible positioning of the ion optic
   are each arranged at the same distance from each other and/or from a center point of the ion optic.

Preferably, an ion optic according to the invention has both several, preferably identical, elements for reversible attachment of the ion optic and several, preferably identical, elements for ensuring reproducible positioning of the ion optic, wherein the elements are each arranged at a regular and equal distance from a center point of the ion optic.

Preferably, the ion optic has a circular shape, and the elements for reversible attachment and for ensuring reproducible positioning of the ion optic are each arranged at equal distances around the center of the circle.

An ion optic according to the invention is preferred, wherein the reversible attachment of the ion optic is effected magnetically.

A magnetic attachment offers a secure and, simultaneously, easy-to-use form of reversible attachment.

The magnets for the reversible attachment of the ion optic are preferably shielded from the ion axis.

It is also preferable to arrange the magnets on the ion optic as far away from the ion channel as possible in order to avoid or at least minimize any manipulation of the ions or the ion beam by the magnets. In cases where the ion channel is located in the center of the ion optic, the magnets for reversible attachment are therefore preferably located at the edge of the ion optic.

An ion optic according to the invention is preferred, wherein the element for ensuring reproducible positioning of the ion optic comprises a sphere (partially recessed in the ion optic) or a sphere segment, preferably a hemisphere.

In the case of the existence of multiple elements for ensuring reproducible positioning, all of these elements preferably comprise a (partially recessed) sphere or a sphere segment.

Preferably, the ion optic is in contact with the attachment point, preferably with a receiving element for the ion optic, only via the spheres or sphere segments in order to ensure the most accurate and reproducible positioning of the ion optic possible. The spheres or sphere segments and their counterparts for inserting or attaching the spheres or sphere segments are typically manufactured with greater precision than, for example, the elements for reversible attachment of the ion optic, which is why higher precision for reproducible positioning can be achieved when the ion optic is in contact exclusively via the spheres or sphere segments.

Therefore, the elements for reversible attachment of the ion optic are preferably designed in such a way that they do not come into contact with the attachment point for the ion optic. This is preferably realized by utilizing a magnetic attraction between the ion optic and the attachment point for reversible attachment, since contact between the magnetically attractive components is not absolutely necessary for the magnetic hold of the ion optic at the attachment point, but rather the magnetic attraction required to hold the ion optic can be made sufficiently strong and designed to ensure secure attachment even if a gap is left between the magnetically attractive components.

An ion optic according to the invention is preferred, wherein the ion optic comprises two, three, or more than three electrically conductive components for the targeted manipulation of ions, preferably for the targeted manipulation of an ion beam.

The electrically conductive components can basically be made of any electrically conductive material. Preferred are electrically conductive components which are produced from a material selected from the group consisting of stainless steel, nickel-plated aluminum and brass, or which comprise one of these materials.

During operation, specific electrical voltages or electrical potentials are applied to the electrically conductive components for targeted manipulation of the ions, and the movement of the ions is manipulated in each case due to interaction with the resulting electric fields.

An ion optic according to the invention is preferred, wherein at least two of the electrically conductive components for targeted manipulation of ions are spatially separated from each other and/or electrically isolated from each other, wherein preferably all of the electrically conductive components for targeted manipulation of ions are spatially separated from each other and/or electrically isolated from each other.

The spatial separation and/or electrical insulation of the electrically conductive components for targeted manipulation of ions is intended to ensure that there is no electrically conductive contact and/or no charge equalization between the electrically conductive components. Spatial separation is preferably achieved by placing electrically insulating material between the electrically conductive components. Polyetheretherketone (PEEK), oxide ceramics, or glass ceramics are preferably used as electrically insulating materials.

Further preferred is an ion optic according to the invention, wherein
different electrical voltages can be applied to at least two of the electrically conductive components for targeted manipulation of ions during operation
and/or
the elements for reversible attachment of the ion optic and/or the elements for ensuring reproducible positioning of the ion optic simultaneously serve as contact points for applying at least two differently adjustable electrical voltages to the ion optic
and/or
at least two of the electrically conductive components for targeted manipulation of ions (preferably all of the components present in the ion optic for targeted manipulation of ions) can be electrically contacted separately from each other via elements for reversible attachment of the ion optic and/or via elements for ensuring reproducible positioning of the ion optic.

In other words, an ion optic according to the invention is preferred, wherein the elements for reversible attachment of the ion optic and/or the elements for ensuring reproducible positioning of the ion optic can be used to apply different electrical voltages to electrically conductive components for targeted manipulation of ions, which are arranged in the ion optic in an electrically insulated manner from each other. For this purpose, a different element for reversible attachment or a different element for ensuring reproducible positioning is used for each electrical contact of the electrically conductive components.

By using the elements for reversible attachment and/or the elements for ensuring reproducible positioning for applying different voltages to the ion optic, the supply of ion optics, which comprise several different electrical components for targeted manipulation of ions (such as a shielding electrode and an acceleration electrode), can in principle also be carried out exclusively via the elements for reversible attachment and/or the elements for ensuring reproducible positioning, thus keeping the design of the ion optic advantageously simple and compact even when supplying the ion optic with several different voltages.

An ion optic according to the invention is preferred, wherein the elements for ensuring reproducible positioning of the ion optic simultaneously serve as contact points for applying at least two differently adjustable electrical voltages to the ion optic. Further preferred is an ion optic according to the invention, wherein only the elements for ensuring reproducible positioning of the ion optic serve as contact points for applying at least two differently adjustable electrical voltages to the ion optic.

The use of only the elements for ensuring reproducible positioning of the ion optic as contact points for applying electrical voltages to the ion optic is also advantageous because, preferably, only these elements are in contact with the attachment point for the ion optic.

Part of the invention is also a set comprising
an ion optic according to the invention or a preferred ion optic according to the invention (as defined above and in the claims), and
a receiving element for the ion optic (preferably integrable into a mass spectrometer),
   wherein the receiving element also comprises (at least) one element for reversible attachment of the ion optic and (at least) one element for ensuring reproducible positioning of the ion optic, and the elements of the ion optic and receiving element for reversible attachment as well as the elements of the ion optic and receiving element for ensuring reproducible positioning are each designed to be complementary to each other,
   and wherein
i) by joining the complementarily designed elements of the ion optic and the receiving element for reversible attachment
and/or
ii) by joining the complementarily designed elements of the ion optic and the receiving element for ensuring reproducible positioning
   an electrical contact for applying an electrical voltage (or an electrical potential) to the ion optic (i.e., at least to parts of the ion optic, such as in particular to one or more electrically conductive components for targeted manipulation of ions) is simultaneously created.

It goes without saying that, in the context of the invention, all elements for reversible attachment and/or all elements for ensuring reproducible positioning, which simultaneously serve as electrical contacts for applying an electrical voltage to the ion optic, are electrically conductive, i.e., they are at least partially made of an electrically conductive material.

A set according to the invention is preferred, wherein by joining the complementarily designed elements of ion optic and receiving element for ensuring reproducible positioning, an electrical contact for applying an electrical voltage to the ion optic is simultaneously created. Further preferred is a set according to the invention, wherein an electrical contact for applying an electrical voltage to the ion optic is created solely by joining the complementarily designed elements of ion optic and receiving element for ensuring reproducible positioning.

The receiving element of the set according to the invention is usually permanently installed in a mass spectrometer.

A set according to the invention is preferred, wherein the ion optic and the receiving element each comprise the same number of elements for reversible attachment of the ion optic and for ensuring reproducible positioning of the ion optic, and all of these elements of the ion optic and receiving element are each designed to be complementary to each other.

A set according to the invention is also preferred, wherein the reversible attachment of the ion optic is effected by pairs of (magnetically attractive) magnets, wherein one magnet of each pair is arranged on the ion optic and the other magnet of each pair is arranged on the receiving element.

A set according to the invention is also preferred, wherein the (at least one) element or ensuring reproducible positioning comprised by the receiving element is designed as a recess preferably as a groove or notch) or as an opening, into which the complementarily designed element of the ion optic can be inserted while taking up a reproducible position. The recess or opening preferably has a circular shape.

Further preferred is a set according to the invention, wherein two rods extending parallel to each other are arranged inside the recess or opening of the receiving element (which serves for ensuring reproducible positioning of the ion optic) and the (at least one) element for ensuring reproducible positioning comprised by the ion optic is designed as a sphere (partially recessed in the ion optic) or sphere segment (preferably as a hemisphere), and the sphere or sphere segment can be placed on the rods located inside the recess or opening while taking up a reproducible position.

The design of the elements for ensuring reproducible positioning as a recess or opening with rods extending parallel therein and a sphere or sphere segment that can be attached thereto enables, on the one hand, reproducible positioning with high accuracy in the micrometer range and (with preferred manufacture of the sphere or sphere segment and the parallel rods of electrically conductive material in each case) excellent electrical contact via the corresponding elements for ensuring reproducible positioning.

A set according to the invention is preferred, wherein the creation of an electrical contact
i) when joining the complementarily designed elements of the ion optic and the receiving element for reversible attachment
and/or
ii) when joining the complementarily designed elements of the ion optic and the receiving element for ensuring reproducible positioning
   is additionally effected by using a movably mounted electrical connecting element, preferably by using a spring contact (also known as a pogo pin).

The use of a movably mounted electrical connecting element additionally serves to establish a secure electrical contact via the complementary elements of the ion optic and the receiving element for reversible attachment and/or via the complementary elements of the ion optic and the receiving element for ensuring reproducible positioning.

Part of the invention is also a mass spectrometer, in particular a MALDI-TOF mass spectrometer, comprising
an ion optic according to the invention or a preferred ion optic according to the invention (as defined above and in the claims)
and/or
a set according to the invention or a preferred set according to the invention comprising an ion optic and a receiving element for the ion optic (as defined above and in the claims).

In the following, the invention is explained in more detail with reference to embodiments and the accompanying figures. The embodiments given below are intended to describe and explain the invention in more detail without limiting its scope.

### BRIEF DESCRIPTION OF THE DRAWINGS

The elements in the attached figures are not necessarily shown to scale, but are primarily intended to illustrate principles of the invention (largely schematically). In the figures, elements corresponding to one another in the different views are identified by the same reference signs.

FIG. 1A is a perspective illustration of a set according to the invention comprising ion optic and a receiving element for the ion optic.

FIG. 1B is an illustration of the set shown in FIG. 1A rotated by 90°.

FIG. 2A is a side view of the set shown in FIGS. 1A and 1B, wherein the ion optic is attached to the receiving element.

FIG. 2B is an illustration of a cross-section of a section of the set shown in FIG. 2A, which further illustrates the arrangement and interaction of the elements for reversible attachment and elements for ensuring reproducible positioning, which are located on both the ion optic and the receiving element and are in each case designed to be complementary to each other.

FIG. 3 is an illustration of the ion optic already shown in the previous figures, with a frontal view of the side of the ion optic on which its elements for reversible attachment and its elements for ensuring reproducible positioning are located.

FIG. 4 illustration of the receiving element already shown in the previous figures, with a frontal view of the side of the receiving element on which its elements for reversible attachment and its elements for ensuring reproducible positioning are located.

### DETAILED DESCRIPTION

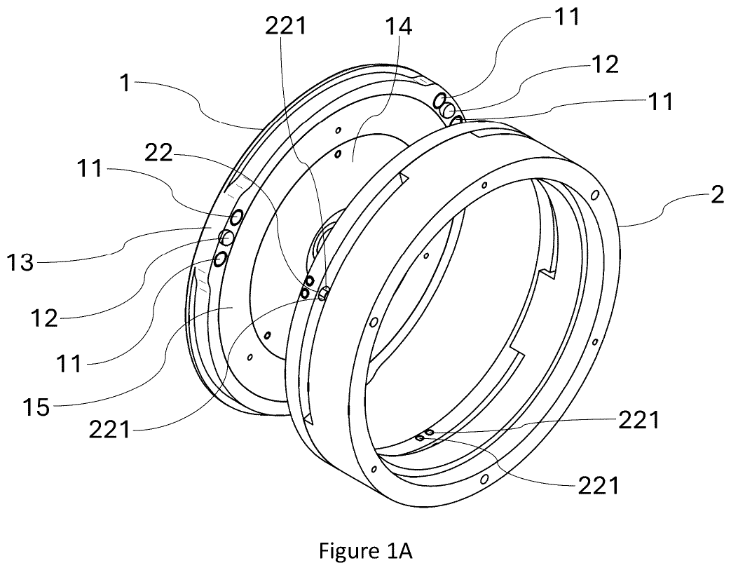

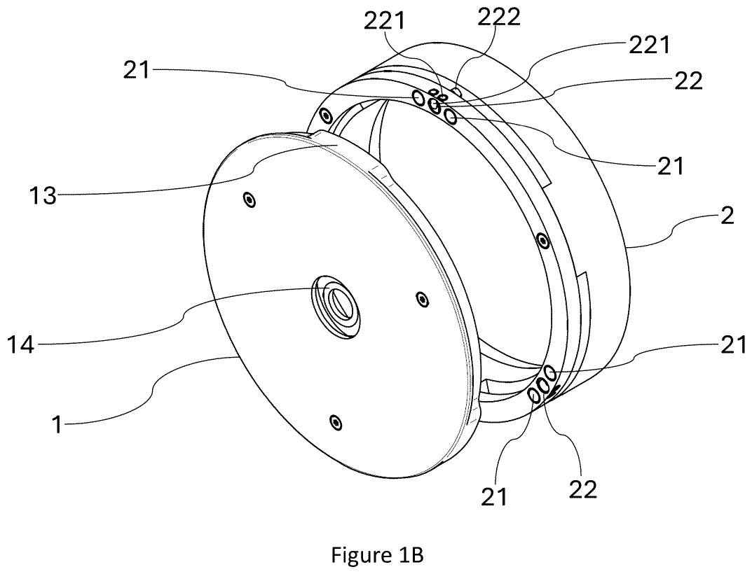

FIGS. 1A and 1B show, from different perspectives, an example of a set according to the invention comprising an ion optic according to the invention 1 and a receiving element 2 for the ion optic 1. The ion optic 1 and the receiving element 2 each have a circular shape. The ion optic 1 comprises, in its outer region, a first electrically conductive component 13 which serves as a shielding electrode during operation for targeted manipulation of ions, and, in its inner region, a second electrically conductive component 14 which serves as an acceleration electrode for targeted manipulation of ions. The acceleration electrode 14 also serves to attract or repel the ions that are normally formed in front of the ion optic 1 during operation and can therefore also be referred to as a repulsion electrode. The shielding electrode 13 and the acceleration electrode 14 are each designed in a ring shape. The acceleration electrode 14 is also designed in multiple stages towards the center. The opening located at the center of the ion optic 1 serves as the entry point for the ions attracted (pulled) and accelerated by the acceleration electrode 14. The shielding electrode 13 and the acceleration electrode 14 are electrically isolated from each other by an electrically insulating material 15 arranged between them, which is designed as a ring made of PEEK.

On the inside, the shielding electrode 13 of the ion optic 1 has three spheres 12 partially recessed in the shielding electrode 13, which are evenly distributed over the circumference of the shielding electrode 13 and serve as elements for ensuring reproducible positioning of the ion optic 1. On the inside, the shielding electrode 13 also has a total of six magnets 11, which serve as elements for reversible attachment of the ion optic 1. The magnets 11 are arranged to the left and right of the partially recessed spheres 12.

The receiving element 2 for the ion optic 1 has the same number of elements as the ion optic for ensuring reproducible positioning and for reversible attachment of the ion optic 1, wherein these elements of the receiving element 2 are each designed to be complementary to the elements of the ion optic 1 and are distributed on the edge of the receiving element 2 in such a way that all of these elements of ion optic 1 and receiving element 2, which are designed to be complementary to each other, can be placed precisely on top of each other when the ion optic 1 is attached to the receiving element 2 and can thus fulfill their function accordingly.

The elements for reversible attachment located on the receiving element 2 are also magnets 21, wherein a magnetic attractive force acts between the magnets 11 and 21 arranged on the ion optic 1 and on the receiving element 2 when a magnet 11 approaches a magnet 21, and the attractive force of all pairs of magnets 11 and 21 is large enough to hold the ion optic 1 firmly on the receiving element 2.

The elements located on the receiving element 2 for ensuring reproducible positioning are circular openings 22, into which the partially recessed spheres 12 of the ion optic 1 can be inserted with a precise fit until they meet two parallel rods 221 in each opening 22, on which the partially recessed spheres 12 are each held in position with a high degree of accuracy. This design of the elements for ensuring reproducible positioning enables reproducible positioning of the ion optic 1 with micrometer-level accuracy.

The partially recessed spheres 12 and the rods 221 extending parallel to each other in the openings 22 are each made of an electrically conductive material, which enables electrical contact with the shielding electrode 13 via the contact between the partially recessed spheres 12 and the rods 221 extending parallel to each other in the openings 22.

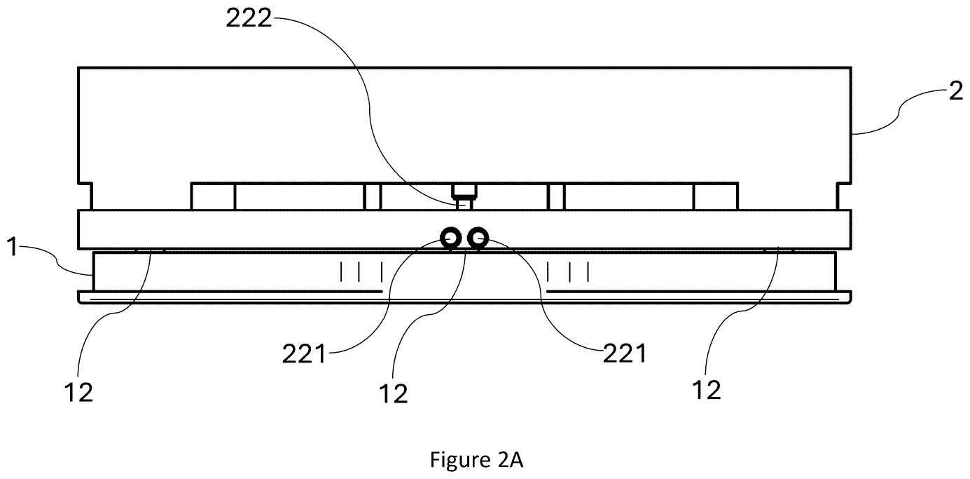

FIG. 2A shows a combination of the set shown in FIGS. 1A and 1B, consisting of ion optic 1 and the receiving element 2 for ion optic 1. In the embodiment shown, when the ion optic 1 is attached to its receiving element 2, contact is made between the partially recessed spheres 12 of the ion optic 1 and the rods 221 extending parallel to each other in the openings 22 of the receiving element 2, via which an electrical voltage can be applied to the shielding electrode 13 of the ion optic. There is no contact between the respective magnets 11 and 21 of ion optic 1 and receiving element 2 when ion optic 1 is attached to receiving element 2, as such contact would have a negative effect on the reproducible positional accuracy with which ion optic 1 can be attached to receiving element 2.

The cross-section shown in FIG. 2B illustrates once again how the elements for reversible attachment and the elements for ensuring reproducible positioning of ion optic 1 and receiving element 2 are aligned with each other when ion optic 1 is attached to receiving element 2. For example, the gap between respective magnets 11 and 21 of ion optic 1 and receiving element 2 can be seen. The contact between the partially recessed sphere 12 of ion optic 1 and the rods 221 extending parallel to each other in the opening 22 of receiving element 2, through which electrical contact is created, can also be seen. The cross-section of FIG. 2B also shows a spring contact (pogo pin) 222, which is also in contact with the rods 221 and which serves to supply power to the rods 221.

In the embodiment shown, voltage is applied to the acceleration electrode 14 via a separate (not shown in the figures) movable electrical contact, which is attached to the receiving element 2 and which comes into contact with the acceleration electrode 14 when the ion optic 1 is attached to the receiving element 2. However, embodiments are also conceivable and comprised by the present invention in which voltage is applied to several or all electrodes of an ion optic via elements for reversible attachment and/or via elements for ensuring reproducible positioning (preferably via elements for ensuring reproducible positioning).

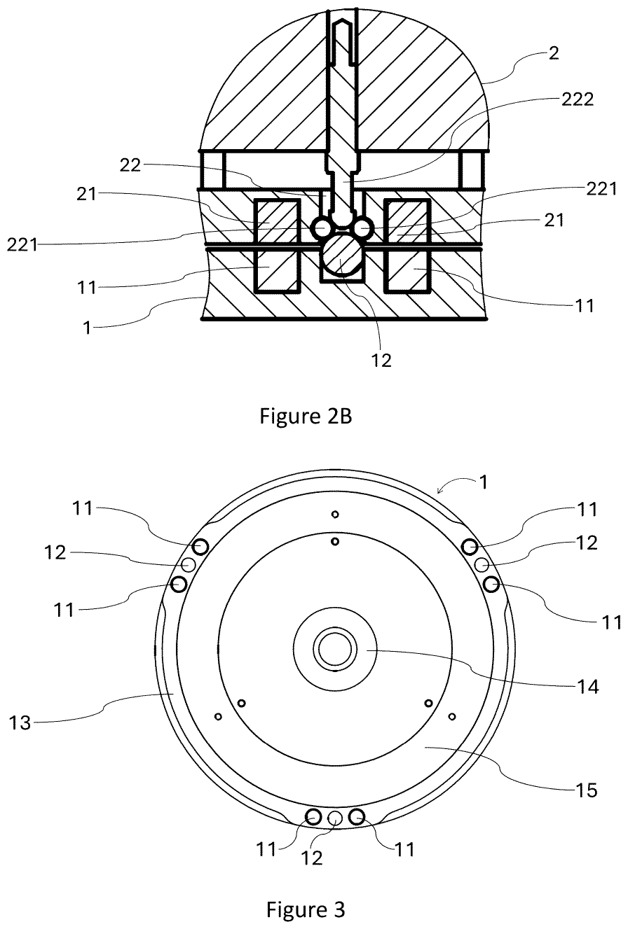

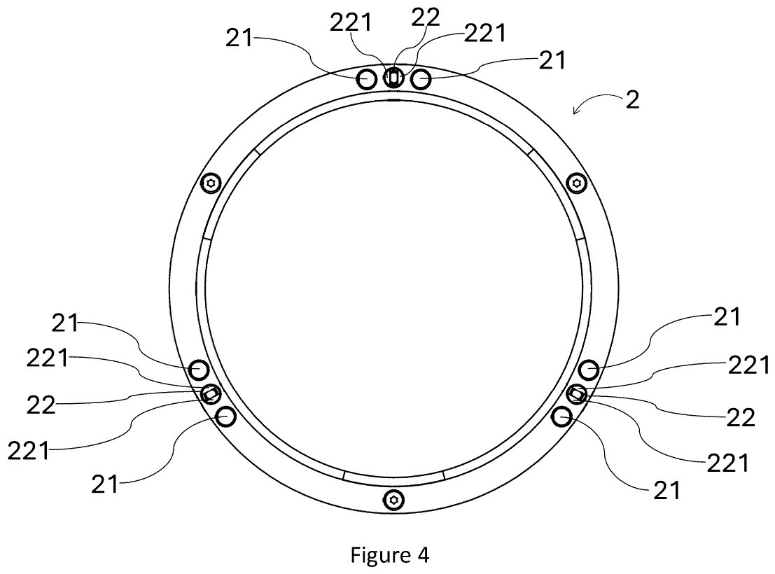

FIGS. 3 and 4 illustrate the ion optic 1 and the receiving element 2 again individually and from a different angle.

### LIST OF REFERENCE SIGNS

1 ion optic
2 receiving element for the ion optic
11 element located on the ion optics for reversible attachment of the ion optic (magnet)
12 element located on the ion optic for ensuring reproducible positioning of the ion optic (partially recessed sphere)
13 first electrically conductive component of the ion optic for targeted manipulation of ions (shielding electrode)
14 second electrically conductive component of the ion optic for targeted manipulation of ions (acceleration electrode)
15 electrically insulating material (PEEK)
21 element located on the receiving element for reversible attachment of the ion optic (magnet)
22 element located on the receiving element for ensuring reproducible positioning of the ion optic (opening for inserting the partially recessed sphere of the ion optic)
221 rod inside the element located on the receiving element for ensuring reproducible positioning of the ion optic (for attachment of the partially recessed sphere of the ion optic)
222 spring contact (pogo pin)

1. An ion optic that can be inserted into and removed from a mass spectrometer in a non-destructive manner, comprising:
an element for reversible attachment of the ion optic inside the mass spectrometer; and
an element for ensuring reproducible positioning of the ion optic in the mass spectrometer, wherein i) the element for reversible attachment of the ion optic and/or ii) the element for ensuring reproducible positioning of the ion optic simultaneously serves as a contact point for applying an electrical voltage to the ion optic.

2. The ion optic according to claim 1, wherein the element for reversible attachment of the ion optic inside the mass spectrometer is one of at least three elements for reversible attachment of the ion optic and/or wherein the element for ensuring reproducible positioning of the ion optic in the mass spectrometer is one of at least three elements for ensuring reproducible positioning of the ion optic.

3. The ion optic according to claim 2, wherein i) the elements for reversible attachment of the ion optic are each arranged at the same distance from each other and/or from a center point of the ion optic and/or ii) the elements for ensuring reproducible positioning of the ion optic are each arranged at the same distance from each other and/or from a center point of the ion optic.

4. The ion optic according to claim 1, wherein the reversible attachment of the ion optic is effected magnetically.

5. The ion optic according to claim 1, wherein the element for ensuring reproducible positioning of the ion optic comprises a sphere or a sphere segment.

6. The ion optic according to claim 5, wherein the element for ensuring reproducible positioning of the ion optic comprises a hemisphere.

7. The ion optic according to claim 1, wherein the ion optic comprises at least two electrically conductive components for targeted manipulation of ions.

8. The ion optic according to claim 7, wherein at least two of the electrically conductive components for targeted manipulation of ions are spatially separated from each other and/or electrically isolated from each other.

9. The ion optic according to claim 8, wherein all of the electrically conductive components for targeted manipulation of ions are spatially separated from each other and/or electrically isolated from each other.

10. The ion optic according to claim 8, wherein different electrical voltages can be applied to at least two of the electrically conductive components for targeted manipulation of ions during operation.

11. The ion optic according to claim 8, wherein the elements for reversible attachment of the ion optic and/or the elements for ensuring reproducible positioning of the ion optic simultaneously serve as contact points for applying at least two differently adjustable electrical voltages to the ion optic.

12. The ion optic according to claim 8, wherein at least two of the electrically conductive components for targeted manipulation of ions can be electrically contacted separately from each other via a plurality of said elements for reversible attachment of the ion optic and/or via a plurality of said elements for ensuring reproducible positioning of the ion optic.

13. A set or system comprising:
the ion optic as defined in claim 1, wherein said element for reversible attachment of the ion optic is a first element for reversible attachment of the ion optic and the element for ensuring reproducible positioning of the ion optic is a first element for ensuring reproducible positioning of the ion optic; and
a receiving element for the ion optic,
wherein the receiving element comprises a second element for reversible attachment of the ion optic that is complementary to the first element for reversible attachment of the ion optic, and a second element for ensuring reproducible positioning of the ion optic that is complementary to the second element for ensuring reproducible positioning of the ion optic,
and wherein
i) by joining the complementarily designed elements of the ion optic and the receiving element for reversible attachment an electrical contact for applying an electrical voltage to the ion optic is simultaneously created
and/or
ii) by joining the complementarily designed elements of the ion optic and the receiving element for ensuring reproducible positioning an electrical contact for applying an electrical voltage to the ion optic is simultaneously created.

14. The set or system according to claim 13, wherein the ion optic and the receiving element each comprise the same respective number of first or second elements for reversible attachment of the ion optic and first or second elements for ensuring reproducible positioning of the ion optic, and all of these elements of the ion optic and receiving element are each designed to be complementary to each other.

15. The set or system according to claim 13, wherein the reversible attachment of the ion optic is effected by pairs of magnets, wherein one magnet of each pair is arranged on the ion optic and the other magnet of each pair is arranged on the receiving element.

16. The set or system according to claim 13, wherein the second element for ensuring reproducible positioning comprises a recess or an opening, into which the complementary first element of the ion optic can be inserted while taking up a reproducible position.

17. The set or system according to claim 16, further comprising two rods extending parallel to each other inside the recess or opening of the receiving element, wherein the first element for ensuring reproducible positioning comprises a sphere or sphere segment that can be placed on the rods located inside the recess or opening while taking up a reproducible position.

18. The set or system according to claim 13, wherein the creation of an electrical contact
i) when joining the complementarily designed elements of the ion optic and the receiving element for reversible attachment
and/or
ii) when joining the complementarily designed elements of the ion optic and the receiving element for ensuring reproducible positioning
is effected by a movably mounted electrical connecting element.

19. The set or system according to claim 18, wherein the movably mounted electrical connecting element is a spring contact.

20. A mass spectrometer comprising an ion optic as defined in claim 1.
